(19) United States
(12) Patent Application Publication
(10) Pub. No.: US 2018/0143741 A1
(43) Pub. Date: May 24, 2018

(54) INTELLIGENT GRAPHICAL FEATURE GENERATION FOR USER CONTENT

(71) Applicant: FlyrTV, Inc., Los Angeles, CA (US)

(72) Inventors: Hassan Uriostegui, Santa Monica, CA (US); Brett O'Brien, Pacific Palisades, CA (US); Hugo V. Elías García, Ecatepec (MX); Héctor M. Carmona Trujano, Los Angeles, CA (US); Taylor McMonigle, Sierra Madre, CA (US); Mathieu F. Welche, Irvine, CA (US); Ivan J. Villavicencio Orrico, Naucalpan (MX)

(21) Appl. No.: 15/821,392

(22) Filed: Nov. 22, 2017

Related U.S. Application Data
(60) Provisional application No. 62/425,875, filed on Nov. 23, 2016.

(51) Int. Cl. G06F 3/0481; G06F 17/30; G06F 17/27

(52) U.S. Cl. CPC G06F 3/0481; G06F 17/30038; G06F 17/2235; G06F 17/2785; G06F 17/30864

(57) ABSTRACT

A mobile application includes a user interface for creating video or hypervideo content comprising a plurality of visual cards. User text input is received for display on one of the visual cards, and text analysis information comprising a tone of the text and a topic of the text and/or one or more keywords of the text is identified based on the text input. Using the text analysis information, one or more media assets are retrieved and a theme for the visual card is selected. The visual card is then constructed based on the text, the media assets, and a style definition associated with the theme. Additional visual cards can be created in a similar manner, resulting in a complete presentation.

### CROSS-REFERENCE TO RELATED APPLICATION

This application claims priority to and the benefit of U.S. Provisional Patent Application No. 62/425,875, filed on Nov. 23, 2016, and entitled “Intelligent Graphical Feature Generation for User Content,” the entirety of which is incorporated by reference herein.

### TECHNICAL FIELD

The present disclosure relates generally to video creation and, more particularly, to systems and methods for intelligent and dynamic creation of adaptive media content on mobile and other devices.

### BACKGROUND

The term “hypervideo” is not new to technological lingo. Experiments from the early 90s attempted to bridge the paradigm of hypertext to the video formats. These and earlier intents focused on the tasks of segmenting and annotating an existing video by adding hyperlinks aimed to control the playback flow by linking to other portions of the video. However, these dated techniques fail to incorporate modern video production and motion graphics concepts and do not live up to the higher standards of mobile user interactivity now established by the videogames industry and social networks.

More specifically, traditional video as an edited sequence of live footage has many challenges. For instance, producing a video that has a high communication value is particularly challenging. The inner language of photographic composition and editing hides nonobvious and complex ingredients to create an attractive final product. To mention some of them, an attractive video production requires the correct balance of an interesting storyline narrative, photographic composition, visual continuity and paced editing, emotive color correction as well as sound production and composition.

From a packing and distribution perspective, once created the final product has to be exported to digital video formats that are based in compressing the individual frames composing the video sequence. Although great advances had been made on this, video files are still large in data size and linearly grow with the duration of the sequence. The process of rendering and compressing to this containers takes time that is also a linear function of the length of the video.

In general these challenges makes the production, distribution and interaction of video an slow and not intuitive process. What is needed, then, are video creation and editing techniques that overcome these challenges.

### SUMMARY

In one aspect, a computer-implemented method for media content generation includes providing an application having a user interface for creating a video on a mobile device, the video comprising a plurality of visual cards; receiving an input of text from a user of the application for display on one of the visual cards; retrieving one or more media assets from an online searchable media service; selecting a theme or template for the visual card; and constructing the visual card based on the text, the one or more media assets, and a style definition associated with the theme or template. Other aspects of the foregoing include corresponding systems and computer programs on non-transitory storage media.

In one implementation, based on the text, text analysis information is identified comprising (i) a tone of the text and (ii) at least one of a topic of the text and one or more keywords of the text. The one or more media assets can be retrieved based on at least a portion of the text analysis information. The template or theme for the visual card can be selected based on at least a portion of the text analysis information. Identifying the text analysis information can include providing the text as input to a language recognition service and receiving as output from the language recognition service the text analysis information. Retrieving the media assets can include providing at least a portion of the text analysis information as input to an online searchable media service and receiving as output from the online searchable media service the one or more media assets. Selecting the template or theme can include identifying whether the tone comprises a positive sentiment, a negative sentiment, or a neutral sentiment, and selecting a theme having elements corresponding to the identified sentiment.

In another implementation, constructing the visual card includes positioning the media assets on the visual card in a universal coordinate space. In a further implementation, constructing the visual card based on the style definition includes applying to the visual card a plurality of visual composition elements identified by the style definition, where the visual composition elements include at least one of a background image, a background pattern, a background color, a border, a gradient, a layout, an object transform, a font type, a font size, and a font color. The style definition can define a set of aesthetically compatible visual composition elements, which can be stored in a file folder structure comprising a plurality of folders each containing a style definition file associated with a particular theme and a plurality of elements compatible with the particular theme.

In yet another implementation, a gesture made by the user on the mobile is detected and, in response to the gesture, a new theme of the visual card is selected and a composition of the visual card based is updated on the new theme. The gesture can be, for example, a swipe on a touch-enabled display screen of the mobile device.

In one implementation, a duration of the visual card within the video is automatically determined, and the video is configured to display the visual card for the determined duration. The duration of the visual card can be automatically determined by calculating the duration based on at least one of a number of characters of text on the visual card, a number of words on the visual card, a number of images on the visual card, and a length of a video or animation on the visual card.

The video can include a hypervideo, and the hypervideo can be exported to a text file, which can be shared with other users and used to regenerate the hypervideo. The plurality of visual cards can include an introduction card, a conclusion card, and at least one intermediate card. The video can be presented to the user on a mobile device, and during presenting the video to the user, a display of the visual card can be automatically adapted based on an aspect ratio of a display screen of the mobile device.

Further aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 depicts an example high-level platform architecture of a system for intelligent generation of media content.

FIG. 2 depicts an example method for intelligent generation of media content.

FIGS. 3A and 3B depict examples of dynamic adaptation of media content based on display aspect ratio.

### DETAILED DESCRIPTION

Described herein, in various implementations, are systems and methods for generation of customizable media content. Whereas, with previous approaches, the video is seen as an immutable resource that has to be segmented and annotated in order to become interactive, the presently described techniques provide for the video itself to be created based on the segments and annotations described by the format, similar to how videogame scenes are created as a game engine needs them. It should be noted as well that, with significant numbers of videos, images, and photos being uploaded to the world wide web, as well as being annotated and indexed due to manual metadata entry and advancements in image recognition, relevant media is often readily accessible online in order to illustrate any given storyline and scene. Such assets are an important part of the building blocks of a video media experience.

Here, video is rethought from a creative perspective that considers the most sophisticated visual paradigms as well as current video production techniques. For instance, nowadays modern television and cinematography highly depends on the use of postproduction to create remarkable sequences that enhances the communication power of every scene. Especially, the technique called “motion graphics” has taken place as one of the highest standards for video creation and creative expression. For instance, the advertisement industry heavily relies on motion graphics as it effectively mixes traditional video footage with animated graphics in the form of billboards (a.k.a. supers) that empower the communication of annotated messages on top of the imagery while creating unique and specialized styles that identify with their brands and products. Movie trailers, news channels and infographics are other media products that heavily rely on these techniques. Video games also use similar techniques, and could be described as “real time motion graphics,” which recreate the sense of motion by programmatically animating otherwise static multimedia assets in a sophisticated pace and rhythm that happens in real time.

The present new paradigm starts building from the notion of real time motion graphics as the primary ingredient to recreate animated video sequences. Thus it helps to clarify the notion that the video footage is just an optional component for the stories as the container motion graphics animation already delivers enough visual information that, once assembled with the correct timing and sequencing, resembles or even overpasses the experience of consuming edited video footage.

In this sense, the motion graphics technique can be considered to have many similarities with the goals of hypertext. By the use of advanced animation and visual techniques, motion graphics can convert otherwise static media and text into an eye catching and interesting representation of information effectively augmenting its communication capabilities in the same way hypertext enhances the communication capabilities of text. Even more, by empowering the ability to hyperlink from within these motion graphics scenes, a metaphor of what video should be is effectively recreated.

Accordingly, the present disclosure describes new video and hypervideo formats that are based mainly on real time motion graphics as the primary video technique instead of traditional video edited footage. The formats are then broken into segments that describe motion graphics scenes with a given duration as part of the whole video storyline. These motion graphic scenes contain diverse media assets including (but not limited to) shapes, colors, images, sounds, video segments and text that are assembled and animated to create the illusion of continuous movement. The user can interrupt the playback flow by tapping at any scene entering into the interactive mode where they can further engage with the graphics assets that once touched may react, extend or link to other multimedia resources. Playback can be resumed at any moment to return to passive consumption mode. This passive to interactive transition is similar to the way interaction is driven on video games where the player controls the storyline pace and rhythm.

To achieve this, we disclose a new creation procedure, packing format and distribution video technology that as whole recreates an authentic experience of instant video and hypervideo production and consumption. This new process reduces a 40+ work hours process involving 4 or more specialized professionals into a fun interactive experience that can be accomplished by a single person in less than one hour. We also disclose a flow for casual prosumers to curate, personalize and share video in less than 30 seconds into their own channels.

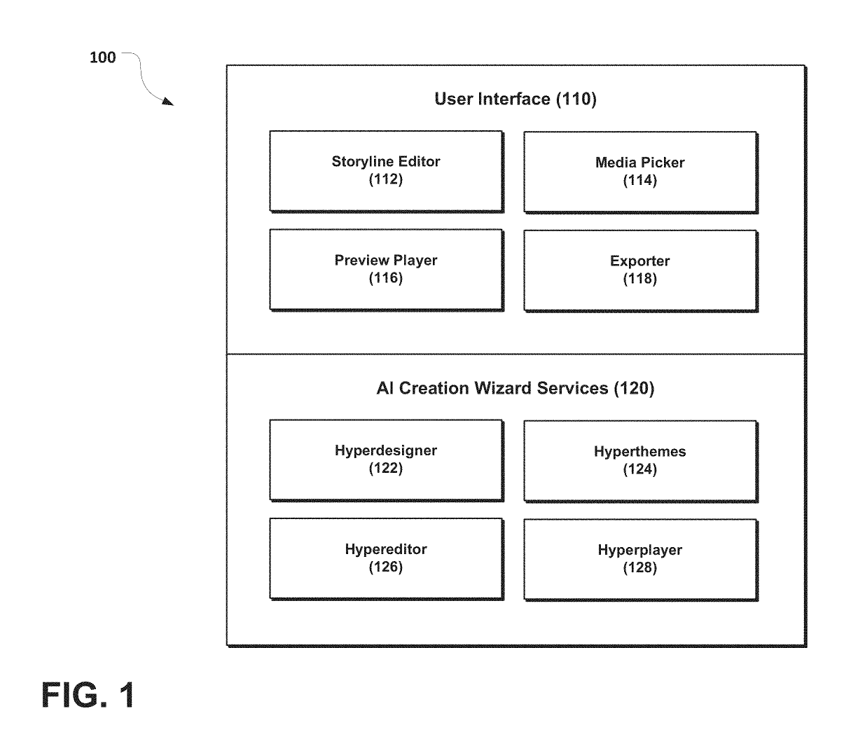

FIG. 1 depicts an example high-level platform architecture of a system for intelligent generation of video and hypervideo media content. The system, in essence, puts the user in the director's seat and uses procedural artificial intelligence (AI) in conjunction with user input and millions of creative options to provide a real-time experience for instant media creation. The use of motion graphics as a core production technique for this video and hypervideo content has similarities to hypertext-based presentations, in that a rich variety of multimedia formats can be linked and presented in an augmented experience that resembles video. Advantageously, the hypervideo format itself can be a universal resource linker and not a media container in and of itself. As such, resulting hypervideo files can be lightweight and agnostic descriptors of how media content, animations, graphics, behaviors, etc. are presented on the screen.

As shown, an application 100 executing on a user device (e.g., a smart phone, tablet computer, smart watch, smart glasses, virtual reality headset, portable computer, laptop, palmtop, gaming device, music device, television, smart or dumb terminal, network computer, personal digital assistant, wireless device, information appliance, workstation, minicomputer, mainframe computer, or other computing device) includes a user interface 110 for creating, editing, viewing and exporting media content. More specifically, the user interface 110 includes Storyline Editor 112, Media Picker 114, Preview Player 116, and Exporter 118 components. Storyline Editor 112 provides an interface within the application 100 to create and edit a video or hypervideo storyline in accordance with the techniques described further below. Media Picker 114 allows a user of the application 100 to select among various media to include in the video or hypervideo, including video, audio, animations, and graphics, that are available locally on the user device or retrieved from remote sources. Preview Player 116 allows the user to preview playback of his created video or hypervideo and, if desired, pause and transition to an editing mode to further revise the video hypervideo. Exporter 118 provides an interface to generate an output based on the video or hypervideo, such as a text-based file that can be used to regenerate the video or hypervideo, or an encoded video recording of the content such that regeneration is not necessary.

Still referring to FIG. 1, the application 100 can include or interface with AI Creation Wizard Services 120 provided by remote servers and/or the user device. Such Services 120 include the Hyperdesigner 122, Hyperthemes 124, Hypereditor 126, and Hyperplayer 128. The Hyperdesigner 122 includes a visual composition algorithm that intelligently combines and manipulates images, text, and other graphical design elements in aesthetically complementary manner using input from a user received through the Storyline Editor 112 interface. The Hyperthemes 124 service makes available to the Hyperdesigner 122 a reusable collection of assets (e.g., borders, background images, etc.) categorized by visual style (theme) for use in the video or hypervideo. The assets can be provided in different formats; for example, a vector format can be used to allow for resizing and other transformations of assets without loss of visual quality. Assets provided by the Hyperthemes 124 service can be retrieved from remote servers (e.g., from a cloud-based media asset storage service, etc.) and cached on the user device for later reuse.

The Hypereditor 126 provides scene analysis for smart pacing, including fast content scanning and region of interest discovery. More specifically, the Hypereditor 126 contains intelligence to calculate an appropriate duration for each scene in the generated media content (further described below). The Hyperplayer 128 provides underlying functionality for the media player component in the application user interface 110, and can play back media in various formats using multiple modes, including a video player mode and a photo gallery mode. A user can switch between passive (viewing only) modes and interactive modes of the Hyperplayer 128, where the interactive modes allow the user to interact with graphical and other assets of the video or hypervideo (e.g., to zoom, enter full screen, pause, open a hyperlink, and so on). Other services provided by the AI Creation Wizard Services 120 can include Hyperchannels, in which a user can post links to and thumbnails of media content in a social feed, chat window, or through other means of communication. Hyperchannels can allow the user to share created media content through various social media avenues, such as YouTube, Facebook, WhatsApp, Vine, Snapchat, Instagram, Twitter, Flickr, and Reddit.

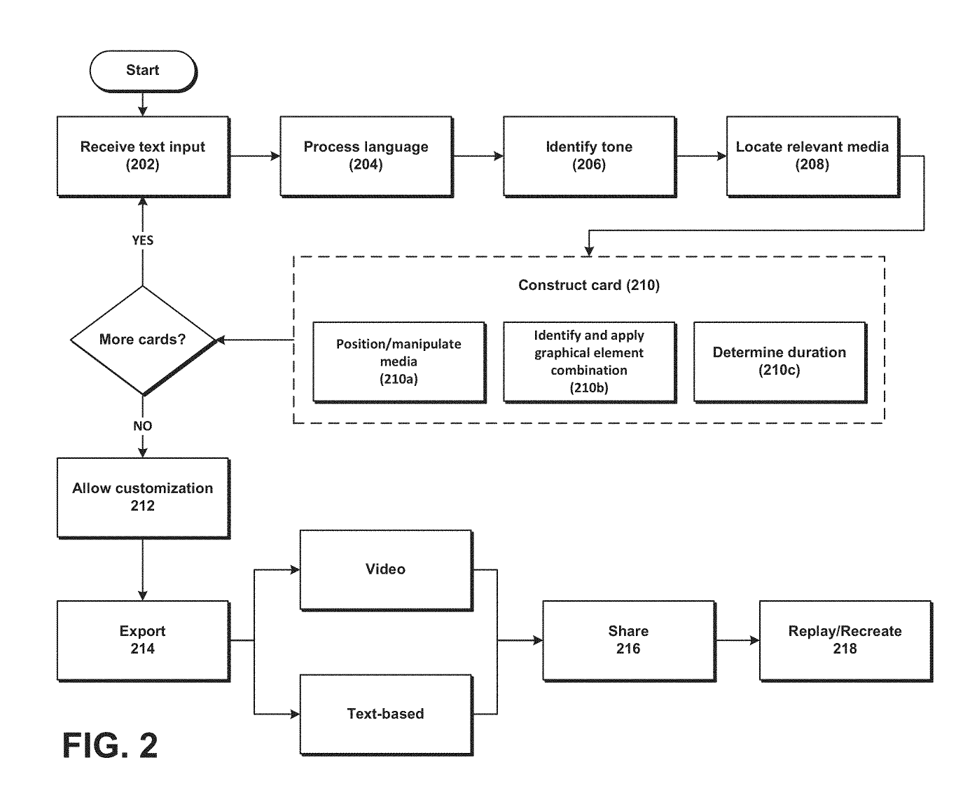

FIG. 2 depicts an example method for intelligent generation of media content according to one implementation. Through the Storyline Editor 112 interface, a user is presented with one or more cards (also referred to as panels or scenes) on which the user can enter text (Step 202). The cards can include an introduction card, one or more intermediate cards, and a conclusion card, each of which can be visually constructed consistently with its position in the content timeline. In Step 204, using language recognition services (e.g., text analytics and linguistics analysis provided through Microsoft Cognitive Services), text entered by the user on a particular card can be analyzed to identify key phrases and topics of the text. Processing the text can also include identifying sentiment (tone) (Step 206). For example, language recognition services can use classification techniques to provide a score indicating whether particular text is likely indicate positive sentiment, neutral sentiment, or negative sentiment. The determined sentiment can then be used as a factor in selecting a general theme (e.g., colors, font types, and other graphical composition elements) to apply to the video or hypervideo (e.g., vibrant colors for positive sentiment, dull colors for negative sentiment, neutral colors for neutral sentiment). In other implementations, analysis of the text is not performed, and the user can manually select from pre-existing templates each having a particular theme.

The language recognition services can also identify keywords and topics, e.g., by receiving text as input and returning a list of strings denoting the key talking points in the input text or returning a list of detected topics identified by key phrases. The keywords and/or topics are then used to retrieve one or more media assets (from a local cache or remote service) that have some association with the keywords/topics (Step 208). For example, if the user enters the text “Hey everybody, winter is coming!” on a card, the language recognition services can identify the key phrase “winter is coming,” and the application, using the AI Creation Wizard Services 120, can retrieve and place on the card an image, animation, or other media related to the HBO television series, “Game of Thrones.” Media assets can be retrieved using a service that has searchable metadata associated with the assets, such as Bing or Google image search. Media assets on a remote server, such as a cloud service, can also be browsed by the user and selected for inclusion on the card. As part of constructing the card (Step 210), the Hyperdesigner 122 can place the media asset on the card along with the text entered by the user in a universal coordinate space, which can operate similarly to HTML/CSS (e.g., position/size components relative to window or screen size) (Step 210a). The user can change the media asset placed on the card by selecting it and choosing among other retrieved suggested assets associated with the entered text.

Other portions of the card are formed using a large collection of assets grouped by theme. In one implementation, the assets are organized in a file folder structure (locally on the user's device or on a remote server), with main theme folders having individual subfolders including such elements as background images and patterns, border graphics, gradient definitions, layout definitions, object transform definitions, and other textual and graphical elements. Each theme or template can have an associated style definition file, similar to a CSS file, that defines the colors, gradients, borders, patterns, text sizes, text borders, and other visual composition elements that are aesthetically compatible. Based on user input text, detected tone, topic, and/or other information, or on manual input or customization by the user, the Hyperdesigner 122 selects a theme and draws from the assets for the theme provided by the Hyperthemes 124 service or the template selected by the user. The Hyperdesigner 122 can intelligently select a combination of random assets, layouts, transforms, object placements, etc., that work together according to the style definition file, and apply the same to the current card (Step 210b). A specific set of styles can also be selected from in the case of introduction and conclusion cards. The result is a card including the user input text, retrieved media asset(s), and a coherent theme. Advantageously, the large collection of theme assets in combination with respective style definition files for the themes allows for a near-infinite number of aesthetically-pleasing card styles (potentially hundreds of trillions of possibilities).

The Hypereditor 126 can evaluate elements on a card to determine an appropriate duration to display the card during playback of the hypervideo (Step 210c). In one implementation, the Hypereditor 126 considers one or more of the following on a particular card to determine its duration: length of text (number of characters and/or words), the presence of emoticons, emojis, or other images, and the length of animations or videos. In one example, the duration of a card is set to a minimum of 1 second, and is increased by 1 second for every five words, 0.5 seconds per image, and 0.25 seconds per emoji. The minimum duration of a card can also be set to the duration of the longest video or animated image on the card. The Hypereditor 126 can also consider a maximum duration window for the entire video, such that the durations of individual cards, when totaled together, fit within the desired window. In some implementations, the user manually sets a duration or adjust the automatically determined duration for each card.

Following initial creation of the card, in Step 212, the user can customize individual elements (e.g., change, move, or otherwise transform background, images, borders, fonts, etc.) or the entire theme. For example, the user can switch among randomly generated but aesthetically consistent themes (defined by style definitions) by interacting with a user input control in the application 100 or performing a gesture, e.g., swiping left/right on a touch-enabled device display screen. The user can also select a random theme that draws on assets from the entire collection of themes. The user can add cards in any order, including adding an introduction and/or conclusion card if desired, until indicating that no further cards are to be added.

Once the media content (video or hypervideo) is complete, the user can export the product in one or more forms (Step 214). In one implementation, the completed product is exported in a text-based format (e.g., JSON or XML, or similar) that does not include video or hypervideo content itself, but provides information identifying the assets (graphics, text, etc.) used, the relative positioning and transformation of the assets in the universal coordinate space, the ordering and duration of cards, and any information needed to regenerate the content as originally created. The information identifying the assets can include, e.g., URLs for remotely available assets and file paths or other local identifiers for assets that are expected to be available on users' devices (e.g., part of the application installation package). The completed product can also be generated using standard video exporting techniques, e.g., as an H.264 encoded video that can be played in a web browser or other video player.

Once exported, the media content can be shared through social media, messaging platforms (e.g., Apple iMessage, Google Hangouts, SMS), emails, or other methods of communication (Step 216). If exported as a text-based file, the file itself can be shared directly or a link to the file, hosted remotely, can be provided to other users. On opening the file using the video player functionality in the application, the content is recreated in its original form (Step 218) and can be viewed. When viewing the video or hypervideo in this form, the user can interact with the content to edit or share it. For example, the user can hold touch, click or otherwise select a card being currently displayed and send a thumbnail of the card to a messaging platform, along with a message provided by the user. In other implementations, if exported as a video file, the content can be uploaded to a video sharing site or otherwise transferred among users. The content can also be exported to other types of formats, such as video formats compatible with Snapchat or Instagram, for example.

In some implementations, the present system includes a set of master templates that each define a general layout intention and composition that is further customizable. The master templates can include, for example, styles covering events (e.g., holidays or other custom events) on an editorial/marketing calendar or other calendar (e.g., red/green color theme for Christmas, and so on) to which users can subscribe. The master templates can also be constructed to match target groups or audiences and can include visual and auditory elements that are directed toward the group (e.g., graphics and music directed towards customers, marketers, etc.). In one example, a master template includes elements related to a brand identity (e.g., logos, color schemes, etc.). Given existing media content created and/or customized using the present system, new media content (videos and hypervideos) can be automatically generated and made available based on a calendar having a set of events. For example, for each event on the calendar, the system can automatically reconstruct an existing video by applying a new master template associated with the event to the existing video, and render the video, on a local device or in the cloud, based on the layout and composition of the template. On occurrence of a calendar event, the reconstructed content can be made available to users that are subscribed to the calendar (e.g., as downloadable files, links, streaming media, etc.). For example, this allows companies to provide to their customers branded, themed content that is automatically generated based on calendar events. Users can also perform customization of event-based content and templates following graphic design, motion graphics, and video editing knowledge that has been converted into algorithmic general-purpose instructions. Once the custom compositions are created these are saved in the user “events” in a user profile. The compositions remain editable, so that a user can open them in a content editor and modify the content. The compositions can be rendered into video and audio muxed files and added to the events so users can use them immediately.

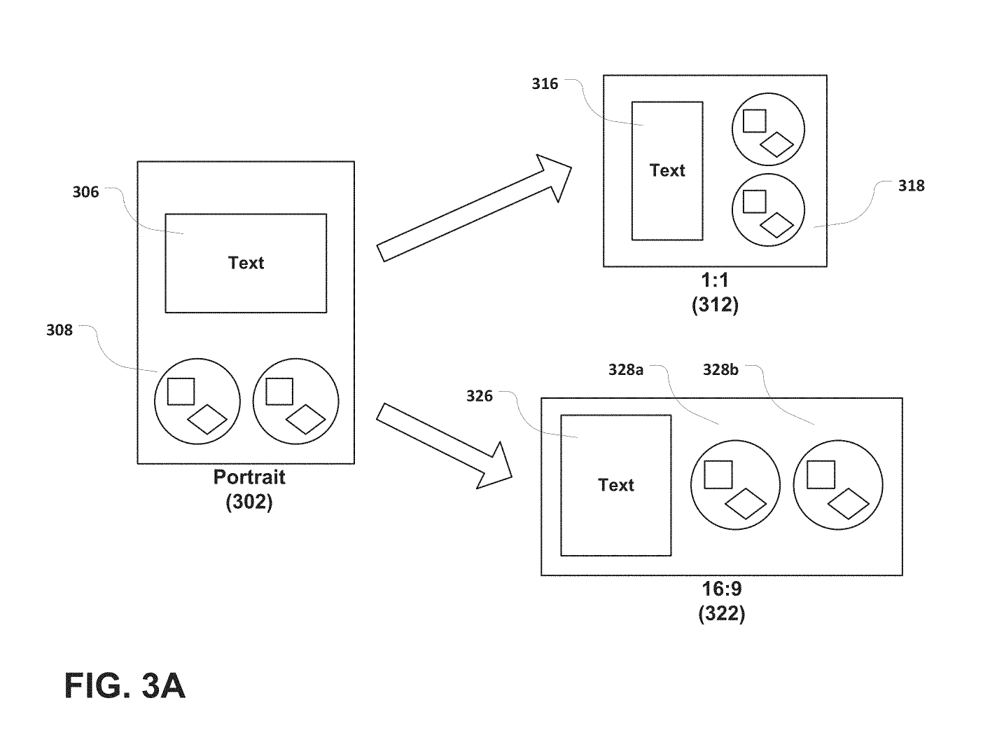

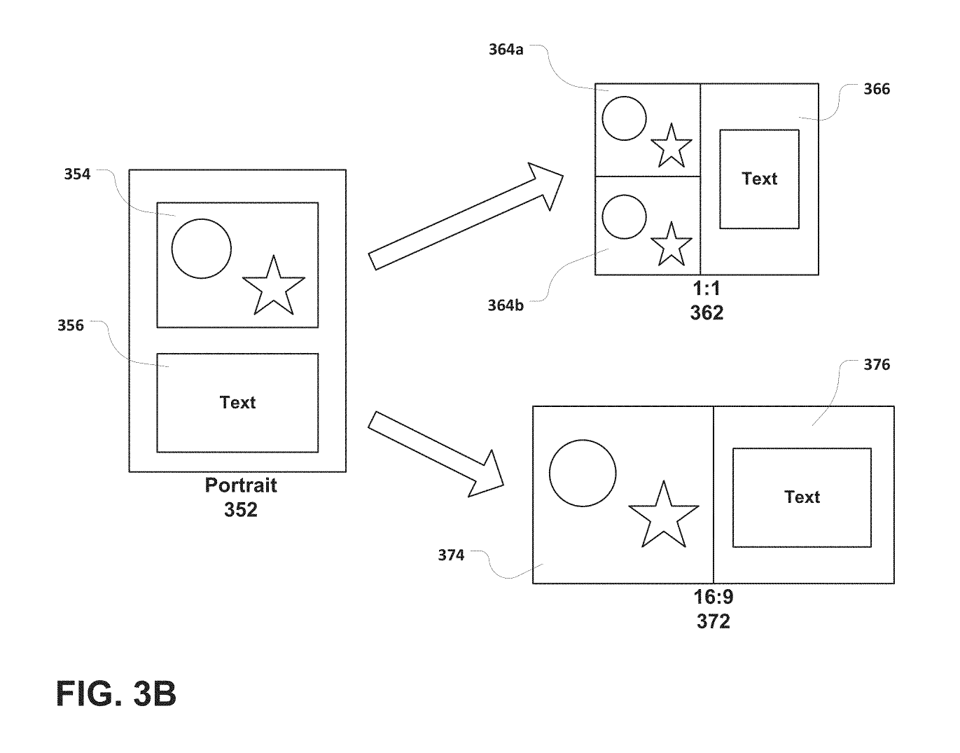

In one implementation, video, animations, and other elements in the presentation are configured to be dynamically responsive to the format of the presentation. In other words, the final representation of the data on the screen is adapted to better fit the presentation canvas, whether it be portrait, landscape, 4:3 aspect ratio, 16:9 aspect ratio, an aspect ratio used by a mobile phone screen, and so on. Referring to FIGS. 3A and 3B, any particular scene can be readapted to maximize the readability of the content for any kind of aspect ratio or screen format. To achieve this, the initial format of the scene is first identified (e.g., landscape, portrait, square, etc.), and the content is segmented into rows and columns. Then, depending on the desired target format (e.g., aspect ratio of 1:4, 4:3, 16:9, 16:10, etc.), the rows are turned into columns, or vice-versa. For example, as shown in FIG. 3A, a change from a portrait format 302 to a square 1:1 format 312 and a landscape 16:9 format 322 results in a text row 306 and a video row 308 being translated into a text column 316, 326 and one or more video columns 318, 328a, 328b. The text, images, videos, and other elements can be disposed in “containers” that have particular sizes and are positioned on the resulting canvas.

Additional optimizations are contemplated to maximize readability. For instance, if the desired container shape for an element (e.g., a video or image) exceeds the original dimensions of the element, then the element can be repeated or tiled. In other instances, the element can be resized, stretched, skewed, or otherwise transformed to fit the desired container size. For text containers, paddings and font size can be optimized with the same goal. As shown in FIG. 3B, a change from a portrait format 352 to a square 1:1 format 362 and a landscape 16:9 format 372 results in a video/image row 354 becoming tiled rows 364a, 364b in the 1:1 format 362, and resized, space-filling column 374 in the 16:9 format 372. Likewise, text row 356 becomes a resized column 366, 376 in both the 1:1 and 16:9 formats 362, 372.

Implementations of the present system can use appropriate hardware or software; for example, the application and other software on the user device and/or remote server(s) can execute on a system capable of running an operating system such as the Microsoft Windows® operating systems, the Apple OS X® operating systems, the Apple iOS® platform, the Google Android™ platform, the Linux® operating system and other variants of UNIX® operating systems, and the like. The software, can be implemented on a general purpose computing device in the form of a computer including a processing unit, a system memory, and a system bus that couples various system components including the system memory to the processing unit.

Additionally or alternatively, some or all of the functionality described herein can be performed remotely, in the cloud, or via software-as-a-service. For example, as described above, certain functions can be performed on one or more servers or other devices that communicate with user devices. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor receives instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

A communications network can connect user devices with one or more servers or devices. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are contemplated. The network can carry TCP/IP protocol communications, and HTTP/HTTPS requests made by a web browser, and the connection between the client device and servers can be communicated over such TCP/IP networks. Other communication protocols are contemplated.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method for media content generation, the method comprising:
providing an application having a user interface for creating a video on a mobile device, the video comprising a plurality of visual cards;
receiving an input of text from a user of the application for display on one of the visual cards;
retrieving one or more media assets from an online searchable media service;
selecting a theme or template for the visual card; and
constructing the visual card based on the text, the one or more media assets, and a style definition associated with the theme or template.

2. The method of claim 1, further comprising identifying, based on the text, text analysis information comprising (i) a tone of the text and (ii) at least one of a topic of the text and one or more keywords of the text.

3. The method of claim 2, wherein the one or more media assets are retrieved based on at least a portion of the text analysis information.

4. The method of claim 2, further comprising selecting the template or theme for the visual card based on at least a portion of the text analysis information.

5. The method of claim 2, wherein identifying the text analysis information comprises providing the text as input to a language recognition service and receiving as output from the language recognition service the text analysis information.

6. The method of claim 2, wherein retrieving the media assets comprises providing at least a portion of the text analysis information as input to an online searchable media service and receiving as output from the online searchable media service the one or more media assets.

7. The method of claim 2, wherein selecting the theme or template comprises:
identifying whether the tone comprises a positive sentiment, a negative sentiment, or a neutral sentiment; and
selecting a theme having elements corresponding to the identified sentiment.

8. The method of claim 1, wherein constructing the visual card comprises positioning the one or more media assets on the visual card in a universal coordinate space.

9. The method of claim 1, wherein constructing the visual card based on the style definition comprises applying to the visual card a plurality of visual composition elements identified by the style definition, the visual composition elements including at least one of a background image, a background pattern, a background color, a border, a gradient, a layout, an object transform, a font type, a font size, and a font color.

10. The method of claim 1, wherein the style definition defines a set of aesthetically compatible visual composition elements.

11. The method of claim 10, further comprising storing the visual composition elements in a file folder structure comprising a plurality of folders each containing a style definition file associated with a particular theme and a plurality of elements compatible with the particular theme.

12. The method of claim 1, further comprising:
detecting a gesture made by the user on the mobile device;
in response to the gesture, selecting a new template or theme of the visual card and updating a composition of the visual card based on the new template or theme.

13. The method of claim 12, wherein the gesture comprises a swipe on a touch-enabled display screen of the mobile device.

14. The method of claim 1, further comprising automatically determining a duration of the visual card within the video and configuring the video to display the visual card for the determined duration.

15. The method of claim 14, wherein automatically determining the duration of the visual card comprises calculating the duration based on at least one of a number of characters of text on the visual card, a number of words on the visual card, a number of images on the visual card, and a length of a video or animation on the visual card.

16. The method of claim 1, wherein the video comprises a hypervideo.

17. The method of claim 16, further comprising exporting the hypervideo to a text file.

18. The method of claim 17, further comprising sharing the text file with one or more other users.

19. The method of claim 17, further comprising regenerating the hypervideo from the text file.

20. The method of claim 1, wherein the plurality of visual cards comprises an introduction card, a conclusion card, and at least one intermediate card.

21. The method of claim 21, further comprising, during a presentation of the video to the user on the mobile device, automatically adapting a display of the visual card based on an aspect ratio of a display screen of the mobile device.

22. A system for media content generation creation, the system comprising:
at least one memory for storing computer-executable instructions; and
at least one processor for executing the instructions stored on the at least one memory, wherein execution of the instructions programs the at least one processor to perform operations comprising:
providing an application having a user interface for creating a video on a mobile device, the video comprising a plurality of visual cards;
receiving an input of text from a user of the application for display on one of the visual cards;
retrieving one or more media assets from an online searchable media service;
selecting a theme or template for the visual card; and
constructing the visual card based on the text, the one or more media assets, and a style definition associated with the theme or template.

23. The system of claim 22, wherein the operations further comprise identifying, based on the text, text analysis information comprising (i) a tone of the text and (ii) at least one of a topic of the text and one or more keywords of the text.

24. The system of claim 23, wherein the one or more media assets are retrieved based on at least a portion of the text analysis information.

25. The system of claim 23, wherein the operations further comprise selecting the template or theme for the visual card based on at least a portion of the text analysis information.

26. The system of claim 23, wherein identifying the text analysis information comprises providing the text as input to a language recognition service and receiving as output from the language recognition service the text analysis information.

27. The system of claim 23, wherein retrieving the media assets comprises providing at least a portion of the text analysis information as input to an online searchable media service and receiving as output from the online searchable media service the one or more media assets.

28. The system of claim 23, wherein selecting the theme or template comprises:
identifying whether the tone comprises a positive sentiment, a negative sentiment, or a neutral sentiment; and
selecting a theme having elements corresponding to the identified sentiment.

29. The system of claim 22, wherein constructing the visual card based on the style definition comprises applying to the visual card a plurality of visual composition elements identified by the style definition, the visual composition elements including at least one of a background image, a background pattern, a background color, a border, a gradient, a layout, an object transform, a font type, a font size, and a font color.

30. The system of claim 22, wherein the operations further comprise:
detecting a gesture made by the user on the mobile device;
in response to the gesture, selecting a new template or theme of the visual card and updating a composition of the visual card based on the new template or theme.
